(19) United States
(12) Patent Application Publication
(10) Pub. No.: US 2019/0083832 A1
(43) Pub. Date: Mar. 21, 2019

(54) SUPERVISORY-GAS-ADJUSTED FRICTION-LOSS COEFFICIENT BASED FIRE SUPPRESSION SPRINKLER SYSTEM

(71) Applicant: Globe Fire Sprinkler Corporation, Standish, MI (US)

(72) Inventors: Stephen J. MEYER, Chester Springs, PA (US); Thomas Edwin ARCHIBALD, Midland, MI (US); Kevin Desmond MAUGHAN, North Kingstown, RI (US); John DESROSIER, Plymouth, MA (US)

(21) Appl. No.: 16/026,556

(22) Filed: Jul. 3, 2018

Related U.S. Application Data
(60) Provisional application No. 62/559,847, filed on Sep. 18, 2017.

(51) Int. Cl. A62C 35/58

(52) U.S. Cl. CPC A62C 35/58

(57) ABSTRACT

A supervisory-fluid-adjusted friction-loss coefficient based fire suppression sprinkler system has an array of pipes in fluid communication with an arrangement of sprinklers. A supervisory fluid sub-assembly is fluid communication with the array of pipes. The supervisory fluid sub-assembly provides a supervisory fluid other than air to the array. A diameter of each respective pipe of the array is determined by a friction-loss formula having a friction-loss coefficient representing a metric corresponding to a corrosion-induced internal surface roughness of each respective pipe of the array The friction-loss coefficient is determined by empirical testing of a representative pipe of the array in accordance with a nationally recognized testing procedure.

### CROSS-REFERENCE TO RELATED APPLICATIONS

This application claims the benefit of priority under 35 USC § 119(e) of U.S. Provisional Patent Application No. 62/559,847 filed Sep. 18, 2017, the contents of which are incorporated herein by reference.

### BACKGROUND OF THE INVENTION

The present invention is generally directed to a supervisory-gas-adjusted friction-loss-coefficient based fire suppression sprinkler system, and more particularly to a fire suppression sprinkler system using a supervisory gas other than air.

Internal corrosion of wet, dry and pre-action fire suppression systems is a growing concern for the fire sprinkler industry. A study by VdS Schadenverhütung GmbH, Cologne, Germany showed that 35% of wet fire sprinkler systems have significant corrosion issues in 25 years and 73% of dry and pre-action fire sprinkler systems have significant corrosion issues in 121/2 years.

Historically, dry and pre-action fire suppression systems have used compressed air as the supervisory gas to pressurize their piping. Presently, National Fire Protection Association (NFPA) Standard for the Installation of Sprinkler Systems (NFPA 13, 2016) hereafter referred to as “NFPA 13”, Section 7.1.5 Air Venting requires a single air vent for each wet pipe system utilizing metallic pipe. Compressed air, however, contains both oxygen and moisture causing the system piping to corrode.

The “Hazen-Williams” Formula is an empirical formula used in the fire sprinkler systems industry when performing hydraulic calculations to determine pipe sizing for the array of piping feeding fire sprinklers. The formula determines how much pressure is lost due to friction from moving water across the inside walls of piping. The individual sprinklers require a specific minimum pressure and flow from them in accordance with prescriptive criteria typically found in NFPA 13.

On a site by site basis, there is a fixed amount of available water pressure to supply the sprinkler system demand. Therefore, it is advantageous to minimize as much as possible, the amount of friction loss experienced through the piping system.

The friction loss in a typical fire sprinkler system is based on multiple factors, the most critical being;
Pipe size (actual internal diameter of the pipe);
Amount of flow through the pipe (typically expressed in gallons per minute (gpm); and
C-Factor of Pipe (also known as coefficient of friction) establishes a given value for the roughness or smoothness of the inside walls of the pipe).

$$p = \frac{4.52 \cdot {Q}^{1.85 }}{{C}^{1.85} \cdot {D}^{4.87}}$$

where ρ=frictional resistance (psi/ft of pipe)
Q=flow (gpm)
C=coefficient of friction for pipe using air as the supervisory gas
D=actual internal diameter of pipe (in.)

From the foregoing Hazen-Williams formula, the following functional relationships among the parameters therein can be deduced:
The larger the pipe, the less friction loss can be expected for a given amount of flow;
The lower the flow through a given pipe size, the less the expected friction loss; and
The higher the C-Factor (Coefficient of Friction) for the pipe used, the lower the expected friction loss in a pipe for a given flow. In other words, the higher the C-Factor, the smoother the inside pipe wall conditions are expected to be.

The effect of a change in the C-factor of the pipe is shown in the examples to follow.

### EXAMPLE 1

### C-Factor=100

A 4″ nominal pipe size using schedule 10 black steel pipe has an actual inside diameter (D) of 4.26 inches. Assume a flow (Q) through this pipe of 600 gpm. Assume the system type to be “Dry”. The C-Factor per NFPA for black steel pipe in a dry system is 100. In view of the foregoing assumptions, the Hazen-Williams formula takes the following form:

$$p = \frac{4.52 \cdot {600}^{1.85 }}{{100}^{1.85} \cdot {4.26}^{4.87}} = 0.107$$

As shown above, the Hazen-Williams formula results in a friction loss of 0.107 psi/ft. of 4″ pipe. Therefore, for 500 feet of 4″ pipe with a C-Factor of 100, flowing 600 gpm there through, the total loss of pressure due to friction would be 53.5 psi.

### EXAMPLE 2

### C-Factor=140

If the C-Factor of the pipe in Example 1 were increased to 140, the Hazen-Williams formula takes the following form:

$$p = \frac{4.52 \cdot {600}^{1.85 }}{{140}^{1.85} \cdot {4.26}^{4.87}} = 0.057$$

As shown above, the Hazen-Williams formula results in a friction loss of 0.057 psi/ft. of 4″ pipe. Accordingly, for the same 500 feet of pipe, the total loss due to friction would be reduced to 28.5 psi.

With this savings in friction loss, there are multiple benefits which can be realized. The reduction in friction loss may allow for a reduction in pipe sizes; either at the cross mains, branchlines, or both. Further, the reduction in friction loss may allow for larger coverage areas to be able to be used with the sprinklers. Still further, if all pipe sizing and sprinkler spacing remain the same, the added “safety factor” of the hydraulic calculations can allow for more flexibility in making pipe routing adjustments in the field.

Approval agencies, design engineering firms and sprinkler system component manufacturers rely upon the C-factors published in standards such as NFPA 13 for their design calculations. The published C-factors are derived from empirical tests assuming that the supervisory fluid is air which is approximately 78% nitrogen and 21% oxygen. Supervisory fluids with reduced oxygen content and, in particular, substantially pure nitrogen are known to mitigate corrosion of the internal surface of piping system thereby reducing surface roughness.

The Hazen-Williams formula is not the only formula relied upon for designing fire sprinkler systems. When the viscosity of the fire suppressing fluid is a factor that should be considered, the fire protection designer may turn to the Darcy-Weisbach formula for determining pipe friction loss. For example, NFPA 13, Section 23.4.4.8.2 for antifreeze (e.g., propylene glycol) systems greater than 40 gal in size, the pipe friction loss shall be calculated using the Darcy-Weisbach equation shown in Section 23.4.2.1.3 using a Moody diagram (see, NFPA 13, Fig. A.23.4.4.7.2) and ε-factors (see, NFPA 13, Table A.23.4.4.8.2) that are representative of aged pipe. The Darcy-Weisbach equation shown in Section 23.4.2.1.3 appears as follows:

$$Δ P = 0.000216 f \frac{l ρ {Q}^{2}}{{d}^{3}} ,$$

where Δρ=friction loss (psi)
f=friction loss factor from Moody diagram
l=length of pipe (ft)
ρ=density of fluid (lb/ft³)
Q=flow in pipe (gpm)
d=inside diameter of pipe (in.)

To use the Moody diagram, the Reynolds number for the fire suppressing fluid and the roughness of the internal surface of the piping, typically identified by the Greek symbol “ε” must be known. (see, Calculating Friction Loss, Darcy-Weisbach Formula vs. Hazen-Williams: Why Darcy is the Appropriate Selection in Large Volume Sprinkler Systems That Use Propylene Glycol, Scott Martorano, The Viking Vorp., March 2006, the contents of which are incorporated herein in the entirety by reference)

Friction loss characteristics of fire sprinkler system piping have changed as a result of evolving corrosion mitigation technology. Published friction loss characteristics may be overly conservative. While conservatism in fire protection system design is generally good, in this case, conservatism may lead to excessively high pump discharge pressures and increased system cost.

The Research Technical Report entitled “Corrosion and Corrosion Mitigation in Fire Protection Systems” by Paul Su and David B. Fuller, FM Global, 2^{nd} Edition, July 2014, (the contents of which are incorporated in the entirety herein by reference) discusses corrosion in fire protection systems (FPS) and concludes, in part, “currently there is no agreed-upon strategy either within the fire protection industry or the National Association of Corrosion Engineers (NACE International) to effectively and efficiently mitigate corrosion in FPS.” (See, page i)

Accordingly, there is a need to install fire sprinkler systems having a design based on calculations adjusted for fire sprinkler systems using a supervisory fluid with reduced oxygen content.

### BRIEF DESCRIPTION OF THE DRAWINGS

The following detailed description of preferred embodiments of the invention will be better understood when read in conjunction with the appended drawings. It should be understood, however, that the invention is not limited to the precise arrangements and instrumentalities shown. In the drawings:

FIG. 1 is schematic of a prior art fire sprinkler system piping layout for a Tree type dry pipe system having a C-factor of 100;

FIG. 2 is schematic of a prior art fire sprinkler system piping layout for a Tree type dry pipe system identical to the system of FIG. 1 with the exception that the C-factor is 140; and

FIG. 3 is a schematic diagram of a prior art Potter INS-2000 nitrogen generation sub-assembly.

### DESCRIPTION OF THE DISCLOSURE

Reference will now be made in detail to embodiments of the invention, examples of which are illustrated in the accompanying drawings. The terminology used in the description of the invention herein is for the purpose of describing particular embodiments only and is not intended to be limiting of the invention.

As used in the description of the invention and the appended claims, the singular forms “a”, “an” and “the” are intended to include the plural forms as well, unless the context clearly indicates otherwise. The words “and/or” as used herein refers to and encompasses any and all possible combinations of one or more of the associated listed items. The words “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, the description of a range such as from 1 to 10 should be considered to have specifically disclosed subranges such as from 1 to 3, from 1 to 4, from 1 to 5, from 2 to 4, from 2 to 10, from 3 to 10 etc., as well as individual numbers within that range, for example, 1, 2, 3, 4, 5, 7, 8, 9, and 10. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

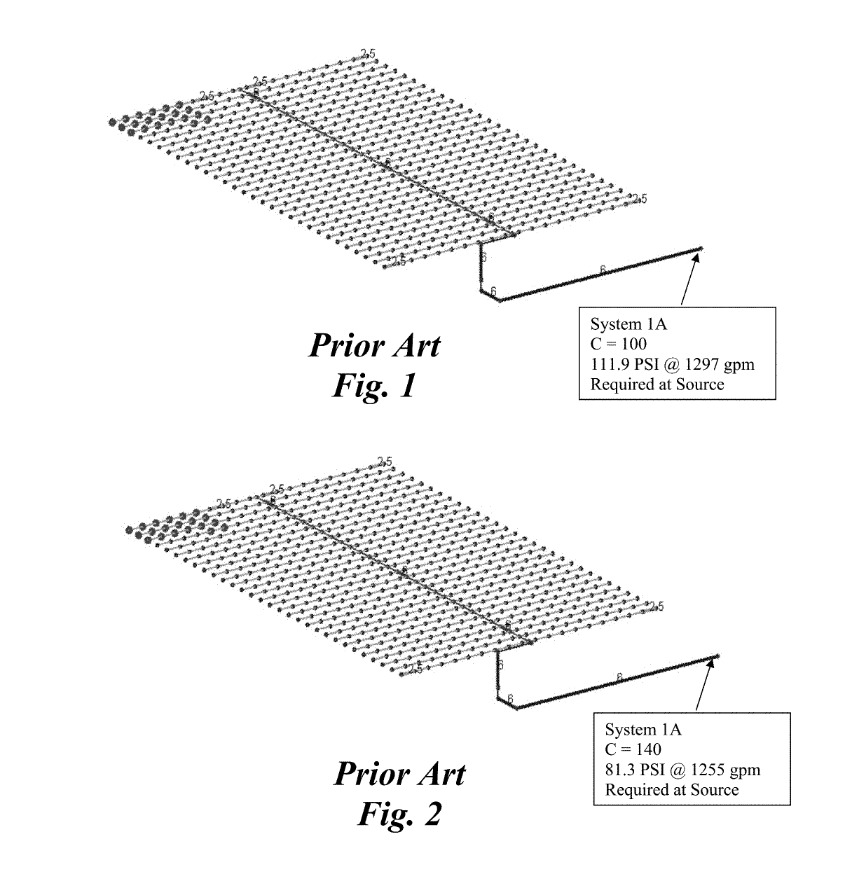

Referring to the drawings in detail, wherein like numerals indicate like elements throughout, there is shown in FIGS. 1 and 2 two examples of a prior art fire sprinkler system piping layout. The two fire sprinkler system piping layouts are identical “Tree” type dry pipe systems. The pipe sizes are the same for both examples. The only difference in the two systems is the C-Factor of the piping. The difference in C-Factor value is presumed to be due to the hypothesis that the system in FIG. 1 uses air as the supervisory fluid and the system in FIG. 2 uses nitrogen as the supervisory fluid and accordingly, the internal surface roughness of the pipe in the FIG. 1 system is greater than the internal surface roughness of the pipe in the FIG. 2 system.

Presently, Underwriters Laboratories (UL) is conducting under applicant's direction a study simulating a nitrogen filled dry pipe system after 50 years of use. In view of data from industries other than the fire sprinkler system industry using nitrogen to mitigate metal pipe corrosion, applicant believes the UL study will conclude that the difference in C-Factor will be in the range of 20-50 greater for the nitrogen system).

The system piping in FIG. 1 utilizes a C-Factor of 100. This is the typical required C-Factor within NFPA 13 for dry pipe systems utilizing steel pipe. The system piping in FIG. 2 utilizes a C-Factor of 140. A standard Hydraulic Design Area of 2000 square feet is utilized for the calculations. The systems are both calculated discharging a density of 0.60 gpm/sq. ft. The hydraulic calculation program used is the Tyco Fire Protection Products SprinkCalc™ III; Program Version 3.2.22.272.

With a C-Factor of 100, the system demand at the point of connection to the source for the system piping in FIG. 1 is 111.9 psi at a 1,297 gpm flow rate. Conversely, when the C-Factor is increased to 140, the ensuing system demand at the source system piping in FIG. 2 is 81.3 psi at a 1,255 gpm flow rate. The increase in C-Factor saved 30.6 psi. This pressure savings may now be used to the designers benefit as stated above.

Although the foregoing examples are for a Tree type dry pipe fire sprinkler system using black raw steel pipe, internally galvanized pipe may be used instead. Initially thought to mitigate corrosion, internally galvanized pipe was assigned a C-Factor of 120 in NFPA 13; however, sampling over time showed that the galvanized pipe with compressed air deteriorated dramatically. As a result, NFPA 13 reduced the C-factor back to 100, the same C-Factor as black steel pipe.

Nitrogen as a supervisory gas may be used to mitigate corrosion not only in dry pipe systems but also in wet pipe systems where nitrogen may replace trapped oxygen. For example, the trapped oxygen by a process referred to as “wet interting” in which a wet pipe system is pre-filled with nitrogen before filling with water.

Broadly stated, a preferred embodiment of the present invention is a supervisory-gas-adjusted friction-loss-coefficient based fire suppression sprinkler system comprising an array of pipes in fluid communication with an arrangement of sprinklers. A supervisory fluid sub-assembly is in fluid communication with the array of pipes and provides a supervisory fluid other than air to the array. A diameter of each respective pipe of the array is determined by a friction-loss formula having a friction-loss coefficient representing a metric corresponding to a corrosion-induced internal surface roughness of each respective pipe of the array. The friction-loss coefficient is determined by empirical testing of a representative pipe of the array in accordance with a nationally recognized testing procedure. One representative example of a nationally recognized testing procedure may be found in Chapter 9, Friction Loss Along A Pipe, Frederick Institute of Technology Online Course, Jun. 9, 2010, the contents of which are incorporated in the entirety herein by reference.

Another preferred embodiment of the present invention is a supervisory-gas-adjusted friction-loss-coefficient based fire suppression sprinkler system comprising an array of pipes in fluid communication with an arrangement of sprinklers, such as the “Tree” type dry pipe systems shown in FIGS. 1 and 2.

A diameter of each respective pipe of the array is determined by a modified Hazen-Williams formula providing,

$$p = \frac{4.52 \cdot {Q}^{1.85 }}{{( C + δ )}^{1.85} \cdot {D}^{4.87}}$$

where ρ=frictional resistance (psi/ft of pipe),
Q=flow (gpm),
C=coefficient of friction for air as the supervisory gas,
D=actual internal diameter of pipe (in.), and
   where the Greek symbol “δ” is a constant representing the difference in the coefficient of friction of a pipe for which air is a supervisory fluid, such as the piping in the system in FIG. 1 having a C-Factor of 100, and the coefficient of friction of a pipe for which a fluid other than air is a supervisory fluid, such as the piping in the system in FIG. 2 having a C-Factor of 140, as determined by empirical testing of representative pipes of the array in accordance with nationally recognized testing procedures.

Preferably, the supervisory fluid is nitrogen. Suggestedly, δ is at least about 10; desireably δ is twenty or more; preferably δ is about thirty to forty-five; and less preferably, δ is at least up to sixty but no more than seventy.

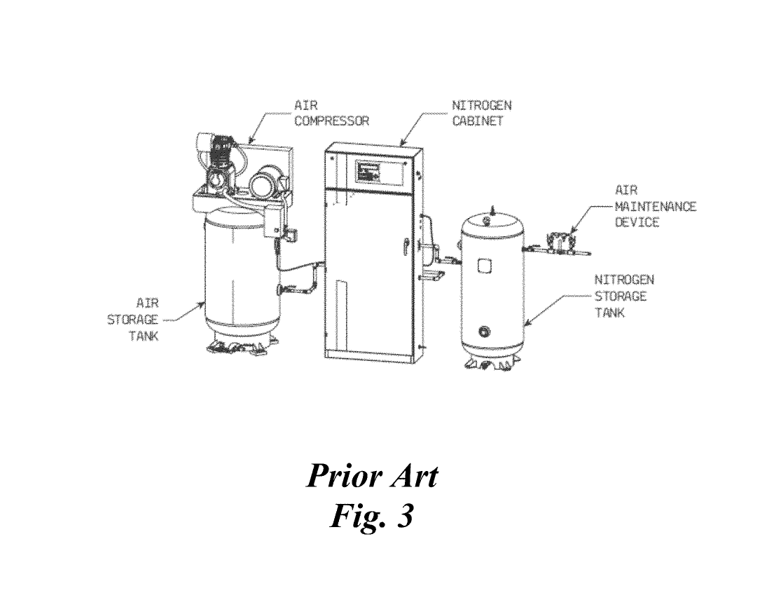

A supervisory gas sub-assembly (see, FIG. 3) is in fluid communication with the array of pipes. The supervisory gas sub-assembly provides a supervisory gas to the array. Preferably, the supervisory gas sub-assembly is a nitrogen generator, such as the Potter INS-2000 nitrogen generator (see, Potter INS-1500/2000 Nitrogen Generators Installation, Operation, and Instruction Manual Number 5403646, Rev B, 2/18, the contents of which are incorporated in the entirety herein by reference) and comprises an air compressor and air storage tank, a nitrogen cabinet housing a nitrogen membrane that separates nitrogen from oxygen and other gases in the air and a nitrogen storage tank connected. The supervisory gas sub-assembly is connected to the array of pipes by an air maintenance device, (see, Globe Model H-1 Air Maintenance Device, Glone Fire Sprinkler Sorp. Brochure GFV-545 June, 2017).

Another preferred embodiment of the present invention is a supervisory-gas-adjusted friction-loss-coefficient based fire suppression sprinkler system comprising an array of pipes in fluid communication with an arrangement of sprinklers, such as the “Tree” type dry pipe systems shown in FIGS. 1 and 2.

A diameter of each respective pipe of the array is determined by a modified Darcy-Weisback formula modified to account for a coefficient of friction of the representative pipe of the array when a fluid other than air is the supervisory fluid, the modified Darcy-Weisback formula providing,

$$Δ P = 0.000216 ( f - δ ) \frac{l ρ {Q}^{2}}{{d}^{3}} ,$$

where Δρ=friction loss (psi),
f=friction loss factor from Moody diagram,
l=length of pipe (ft),
ρ=density of fluid (lb/ft³),
Q=flow in pipe (gpm),
d=inside diameter of pipe (in.),and
   where δ is a constant representing a difference in a friction loss factor for an aged pipe for which air is a supervisory fluid and a friction loss factor for an aged pipe for which a fluid other than air is the supervisory fluid as determined by empirical testing of representative pipes of the array in accordance with nationally recognized testing procedures.

Preferably, the supervisory fluid is nitrogen. Suggestedly, δ is at least about 10; desireably δ is twenty or more; preferably δ is about thirty to forty-five; and less preferably, δ is at least up to sixty but no more than seventy.

Those skilled in the art of fire sprinkler system design will appreciate that the constant δ in the modified Hazen-Williams formula and the modified Darcy-Weisback formula can have a range of values depending on the type and size of the pipe, the initial internal surface roughness and the degradation of the surface due, in part, to corrosion depending of the supervisory fluid used. Further, those skilled in the art will appreciate that the C-Factors for the Hazen-Williams formula and δ-factors Darcy-Weisback formula in the currently approved standards documents are empirically determined by test procedures that do not take into account the use of different supervisory fluids and must be adjusted.

Still further, it will be appreciated by those skilled in the art that changes could be made to the embodiment described above without departing from the broad inventive concept thereof. It is understood, therefore, that the invention is not limited to the particular embodiment disclosed, but it is intended to cover modifications within the spirit and scope of the disclosure.

All references, patent applications, and patents mentioned in the foregoing disclosure are incorporated herein by reference in their entirety.

we claim:

1. A supervisory-fluid-adjusted friction-loss coefficient based fire suppression sprinkler system comprising:
an array of pipes in fluid communication with an arrangement of sprinklers; and
a supervisory fluid sub-assembly in fluid communication with the array of pipes, the supervisory fluid sub-assembly providing a supervisory fluid other than air to the array,
wherein a diameter of each respective pipe of the array is determined by a friction-loss formula having a friction-loss coefficient representing a metric corresponding to a corrosion-induced internal surface roughness of each respective pipe of the array, the friction-loss coefficient determined by empirical testing of a representative pipe of the array in accordance with a nationally recognized testing procedure.

2. The fire suppression sprinkler system according to claim 1, wherein the friction-loss formula is a Hazen-Williams formula modified to account for a coefficient of friction of the representative pipe of the array when a fluid other than air is the supervisory fluid, the modified Hazen-Williams formula providing,
$$p = \frac{4.52 \cdot {Q}^{1.85 }}{{( C + δ )}^{1.85} \cdot {D}^{4.87}}$$
where ρ=frictional resistance (psi/ft of pipe),
Q=flow (gpm),
C=coefficient of friction for air as the supervisory gas
D=actual internal diameter of pipe (in.), and
where δ is a constant representing a difference in a coefficient of friction for an aged pipe for which air is a supervisory fluid and a coefficient of friction for an aged pipe for which a fluid other than air is the supervisory fluid.

3. The fire suppression sprinkler system according to claim 2, wherein the supervisory fluid is nitrogen.

4. The fire suppression sprinkler system according to claim 3, wherein δ is at least about 10.

5. The fire suppression sprinkler system according to claim 3, wherein δ is twenty or more.

6. The fire suppression sprinkler system according to claim 3, wherein δ is about thirty to forty-five.

7. The fire suppression sprinkler system according to claim 3, wherein δ is at least up to sixty but no more than seventy.

8. The fire suppression sprinkler system according to claim 1, wherein the friction-loss formula is a Darcy-Weisback formula modified to account for a coefficient of friction of the representative pipe of the array when a fluid other than air is the supervisory fluid, the modified Darcy-Weisback formula providing,
$$Δ P = 0.000216 ( f - δ ) \frac{l ρ {Q}^{2}}{{d}^{3}} ,$$
where Δρ=friction loss (psi),
f=friction loss factor from Moody diagram,
l=length of pipe (ft),
ρ=density of fluid (lb/ft³),
Q=flow in pipe (gpm),
d=inside diameter of pipe (in.),and
where δ is a constant representing a difference in a coefficient of friction of an aged pipe for which air is a supervisory fluid and a coefficient of friction of an aged pipe for which a fluid other than air is the supervisory fluid.

9. The fire suppression sprinkler system according to claim 8, wherein the supervisory fluid is nitrogen.

10. The fire suppression sprinkler system according to claim 8, wherein δ is at least about 10.

11. The fire suppression sprinkler system according to claim 8, wherein δ is twenty or more.

12. The fire suppression sprinkler system according to claim 8, wherein δ is about thirty to forty-five.

13. The fire suppression sprinkler system according to claim 8, wherein δ is at least up to sixty but no more than seventy.
